(19) United States
(12) Patent Application Publication
(10) Pub. No.: US 2014/0135106 A1
(43) Pub. Date: May 15, 2014

(54) AUTOMATED SOCIAL BONUS HARVESTING

(71) Applicant: WMS GAMING, INC., Waukegan, IL (US)

(72) Inventors: Richard B. Robbins, Glenview, IL (US); Andrew C. Guinn, Chicago, IL (US); Ernesto Perez-Gonzalez, Chicago, IL (US)

(73) Assignee: WMS Gaming, Inc., Waukegan, IL (US)

(21) Appl. No.: 13/789,246

(22) Filed: Mar. 7, 2013

Related U.S. Application Data
(60) Provisional application No. 61/725,314, filed on Nov. 12, 2012.

(51) Int. Cl. A63F 13/12

(52) U.S. Cl. CPC A63F 13/12
USPC 463/25

(57) ABSTRACT

Systems and methods are described for a proxy application that accesses multiple online games on behalf of a user and programmatically satisfies various criteria for bonus awards provided by the online games. The proxy application may be a stand-alone application or it may be a component of another application such as a plug-in for a web browser.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2013, WMS Gaming, Inc.

### FIELD

Embodiments of the inventive subject matter relate generally to online social game systems, and more particularly to harvesting bonuses provided by online social game systems.

### BACKGROUND

Online games such as online skill games, simulation games, wagering games and the like have become more and more popular over the years. Online games are typically server based games that are provided to online gaming clients. Recently, online games have been proliferating on social networking sites such as Facebook. Generally, the popularity of a game depends on the likelihood (or perceived likelihood) of winning the game and the intrinsic entertainment value of the game relative to other available gaming options. Players are likely to be attracted to the most entertaining and exciting games. Shrewd operators consequently strive to employ the most entertaining and exciting games, features, and enhancements available because such games attract frequent play and hence increase profitability to the operator or provider of the game. Therefore, there is a continuing need for game developers to continuously develop new games and gaming enhancements that will attract frequent play.

One way game developers attempt to attract frequent play is to provide bonuses or rewards for frequent game play. For example, an online game may provide points, virtual energy, virtual lives or virtual currency if a player returns to play an online game within a certain period of time after the most recent play. As another example, an online game may provide a bonus or reward for completing certain tasks or actions within the online game.

It is often the case that a person will play multiple online games. The multiplicity of games and reward criteria can make it difficult for the person to remember to logon to a game to collect bonuses or to remember the criteria for being awarded a bonus.

### BRIEF DESCRIPTION OF THE FIGURES

Embodiments of the invention are illustrated in the Figures of the accompanying drawings in which:

FIG. 1 a block diagram illustrating components of a system for harvesting bonus awards provided by online games according to embodiments.

FIG. 2 is a flowchart illustrating a method for automatically satisfying bonus criteria for multiple online games according to embodiments.

FIG. 3 illustrates an example screen image according to embodiments.

FIG. 4 illustrates an example screen image where an online game having bonus criteria that has been satisfied is highlighted according to embodiments.

FIG. 5 is a flowchart of a method for satisfying a challenge-response screen by a proxy application according to embodiments.

FIG. 6 is a block diagram of an example embodiment of a computer system upon which embodiments of the inventive subject matter can execute.

### DESCRIPTION OF THE EMBODIMENTS

This description of the embodiments is divided into five sections. The first section provides an introduction to embodiments of the invention, while the second section describes example operating environment. The third section describes example operations performed by some embodiments and the fourth section describes example computing systems supporting the embodiments in more detail. The fifth section presents some general comments.

### Introduction

In general, the embodiments include a proxy application that accesses multiple online games on behalf of a user and programmatically satisfies various criteria for bonus awards provided by the online games. The proxy application may be a stand-alone application or it may be a component of another application such as a plug-in for a web browser.

The disclosure below and the claims refer to the term bonus criteria. The term “criteria” is commonly used as both a singular and plural noun. As used in the specification and the claims, the term criteria may refer to one or more criteria, that is, one or more conditions, standards, parameters etc. that may be used to determine if a bonus is awarded.

### Operating Environment

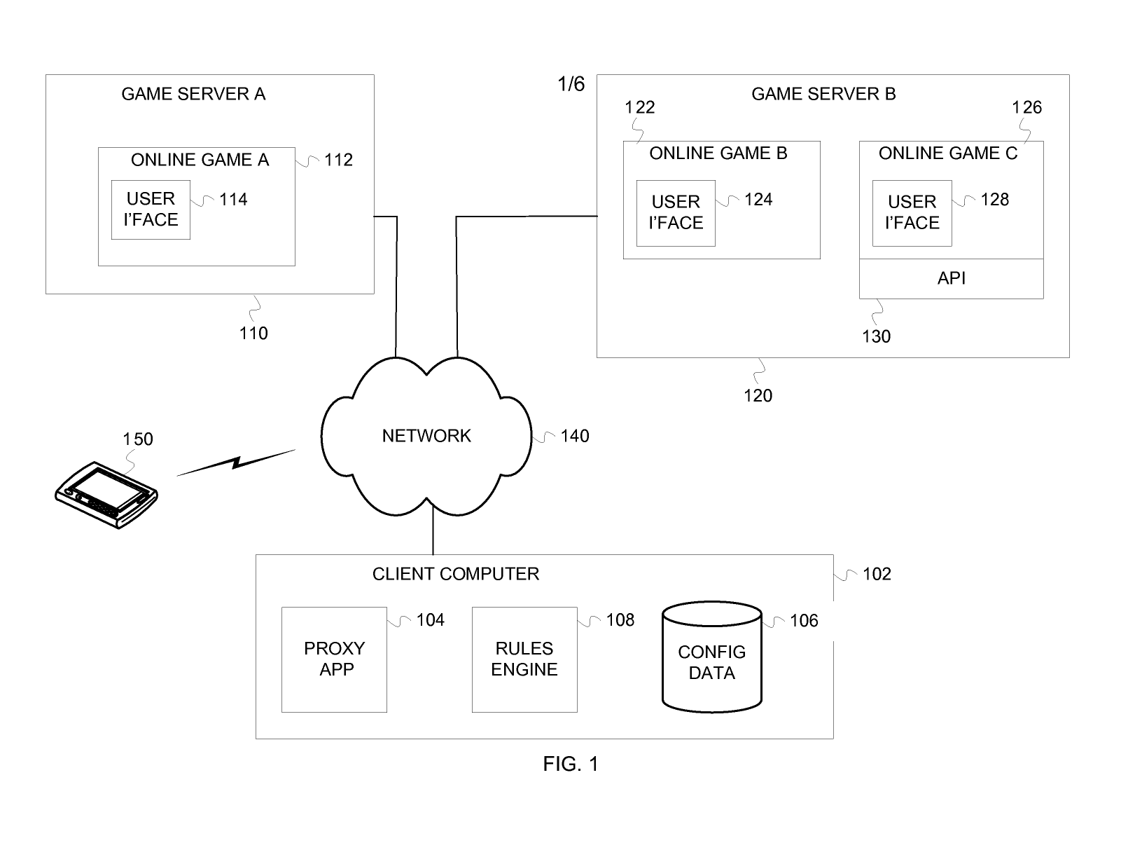

FIG. 1 is a block diagram illustrating components of a system 100 for harvesting bonus awards provided by online games according to embodiments. In some embodiments, system 100 includes one or more online game servers, for example online game servers 110 and 120, client computer 102 and optionally a mobile device 150, any of which may be communicably coupled through network 140. Network 140 may be any combination of one or more wired or wireless networks that provide a communications path between components of system 100. In some embodiments, network 140 is the Internet.

Online game servers 110 and 120 are server computing systems that provide online games 112, 122 and 126 to clients such as client computer 102. Online game servers 110 and 120 may be from different providers. For example, online game server 110 may be provided by WMS Gaming, Inc. at the URL (Uniform Resource Locator) “playerslife.com” or “jackpotparty.com”, while online game server 120 may be provided by Facebook at the URL “facebook.com.” Although illustrated as one server in FIG. 1, an online game provider may actually maintain many (hundreds or even thousands) of servers in order to provide the computing resources appropriate to the number of client computers 110 that access and play the online games.

Online games 112, 122 and 126 may be any of various types of online games now known or developed in the future. For example, online games 112, 122 and 126 may be simulation games, skill games, social wagering games, strategy games etc. Simulation games include games such as “Farmville,” “Sim City Social,” “Car Town” etc. Social versions of wagering games include games such as online slots, bingo, keno, poker or other wagering games. Skill games include games such as online versions of “Bejeweled”, “Words for Friends” etc. The embodiments are not limited to any particular online game. As illustrated in FIG. 1, an online game server 120 and provide more than one online game 122 and 126. While two game are illustrated in the example shown in FIG. 1, it will be appreciated that an online game server can provide more than two different online games.

Online games 112, 122 and 126 each provide a bonus award. The bonus award for different games may be different. For example, in some online games, a bonus award may be points. In other online games, the bonus may be a virtual currency that can be used to purchase virtual or real goods and services. In still further online games, the bonus may be an extra life or additional energy for a character or avatar.

Additionally, the criteria for being awarded a bonus may vary from one online game to the next. In some online games, the criteria may be as simple as logging into the online game after a period of time has passed since the last login. For example, a player may be awarded points if they login after twenty-four hours have passed since the last login. In other online games, the criteria may be answering a question correctly, where a different question may be periodically provided to a player. In further online games, the criteria may be the successful completion of a “mini-game”, i.e., a game within the game. The embodiments are not limited to any particular bonus award criteria.

Client computer 102 may be used to access an online game server (e.g., game servers 110 and 120) to play online games 112. 122 and 126. Client computer 120 may be any type of computing device, including desktop computers, laptop computers, tablet computers, personal digital assistants, mobile phones etc. The embodiments are not limited to any particular type of client computer 102. Client computer 102 includes proxy application 104 and configuration data 106. Proxy application 104 is an application that executes program logic to automatically log on to and access multiple online games and executes algorithms and/or heuristics to perform actions that satisfy bonus criteria for the online games on behalf of a user. Proxy application 104 may take any of many forms. For example, in some embodiments, proxy application 104 may be a standalone application. In alternative embodiments, proxy application 104 may be a plug-in or add-on, for example, a plug-in for a web browser such as Internet Explorer, Firefox, or Chrome. In further alternative embodiments, proxy application 104 may be part of a web service.

Configuration data 106 is a database that contains data that may be used by proxy application 104 in the course of logging on, accessing, and playing an online game. Various types of data may be maintained in configuration data 106. For example, configuration data 106 may include URLs, user ids, passwords, game identification and other information useful in accessing and playing an online game.

In some embodiments, system 100 may include a mobile device 150. In such embodiments, proxy application 104 may communicate information to mobile device 150 in order to notify a remote user (remote from the perspective of the proxy application) of a bonus related event and to obtain information that may be necessary for the proxy application to login to an online game (for example, a response to a challenge-response screen).

Proxy application 104 may use various mechanisms to login and access an online game 112, 122 or 126. For example, in some embodiments, proxy application 104 may use screen scraping technology to access a screen of an online game and interpret the information found on the screen. In such embodiments, proxy application navigates a user interface 114, 124 and 128 of the online games, including login screens and potentially other screens that are used to satisfy criteria for receiving a bonus award. In alternative embodiments, proxy application 104 may access an API (Application Program Interface) that defines methods and data used to access an online game.

In some embodiments, proxy application 104 may include or access a rules engine 108. Rules for rules engine 108 may comprise statements, facts, conditions and other logical components. Rules engine 108 may be configured to read the set of rules and apply the rules to various situations that may be encountered by proxy application 104.

Although FIG. 1 describes some embodiments, the following sections describe many other features and embodiments. Further details on the operation of system 100 and proxy application 104 are provided below.

### Example Operations

This section describes operations associated with some embodiments of the invention. In the discussion below, the flow diagrams will be described with reference to the block diagrams presented above. However, in some embodiments, the operations can be performed by logic not described in the block diagrams.

In certain embodiments, the operations can be performed by executing instructions residing on machine-readable media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform less than all the operations shown in any flow diagram.

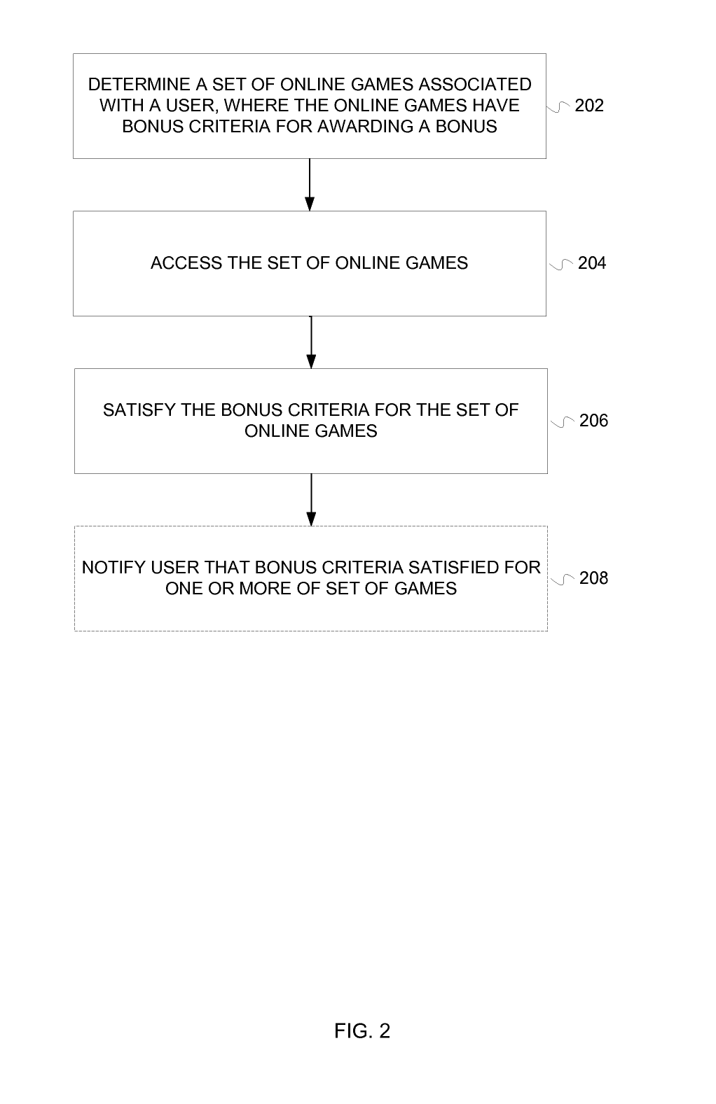

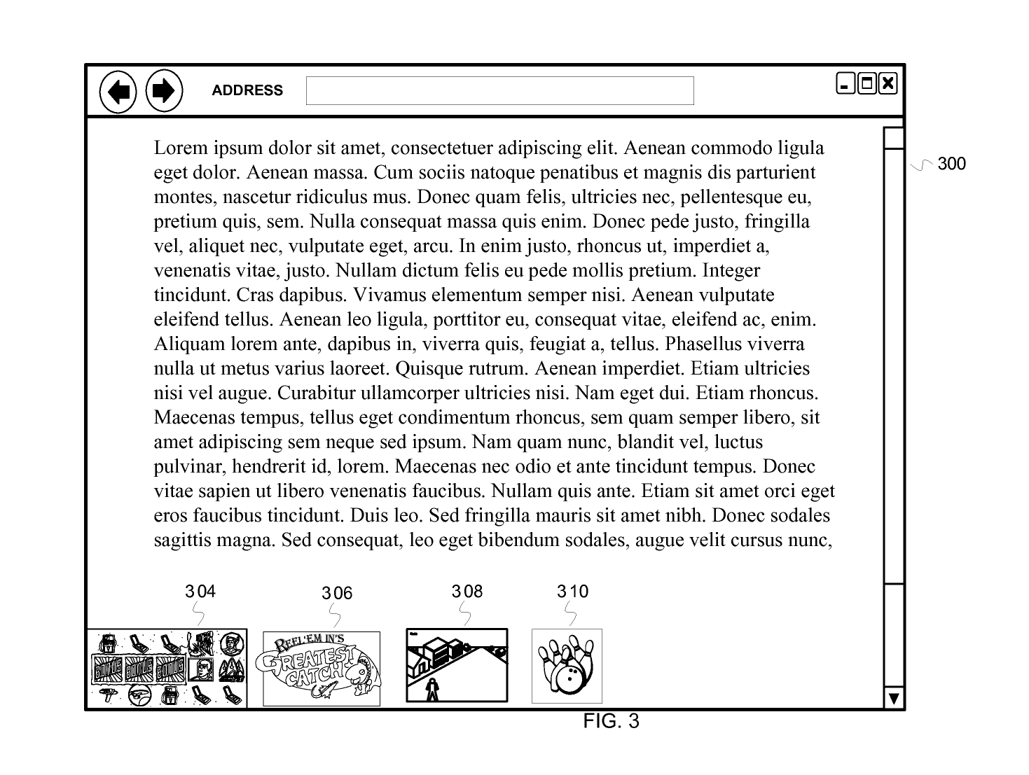

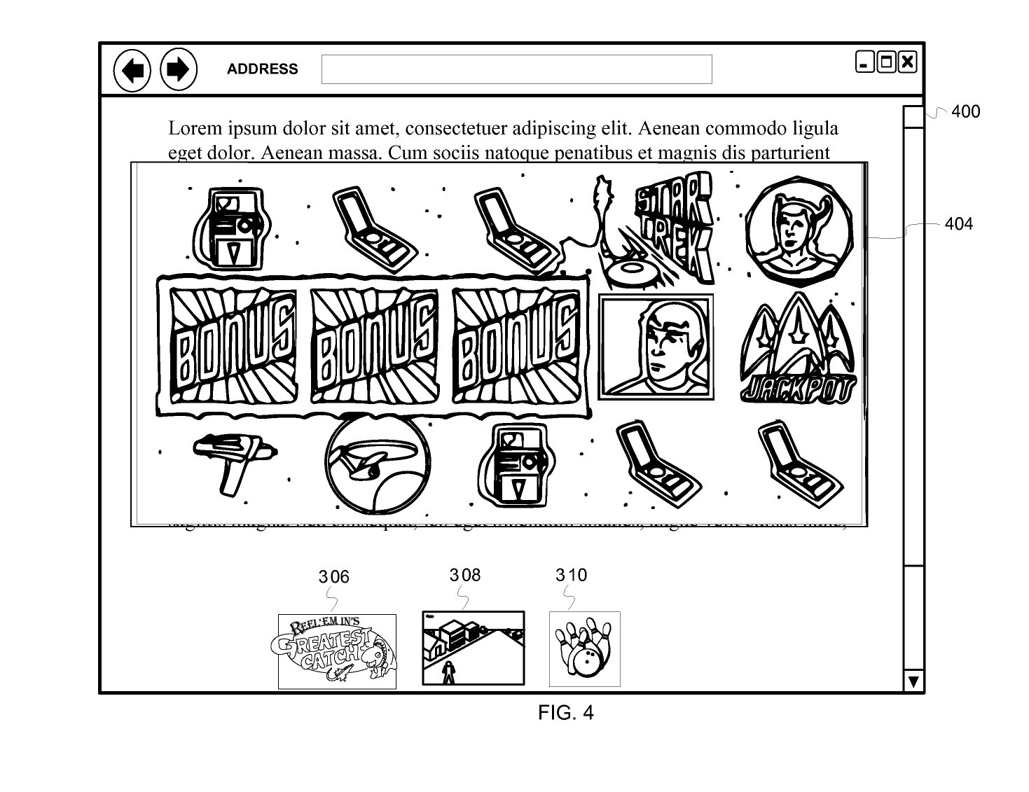

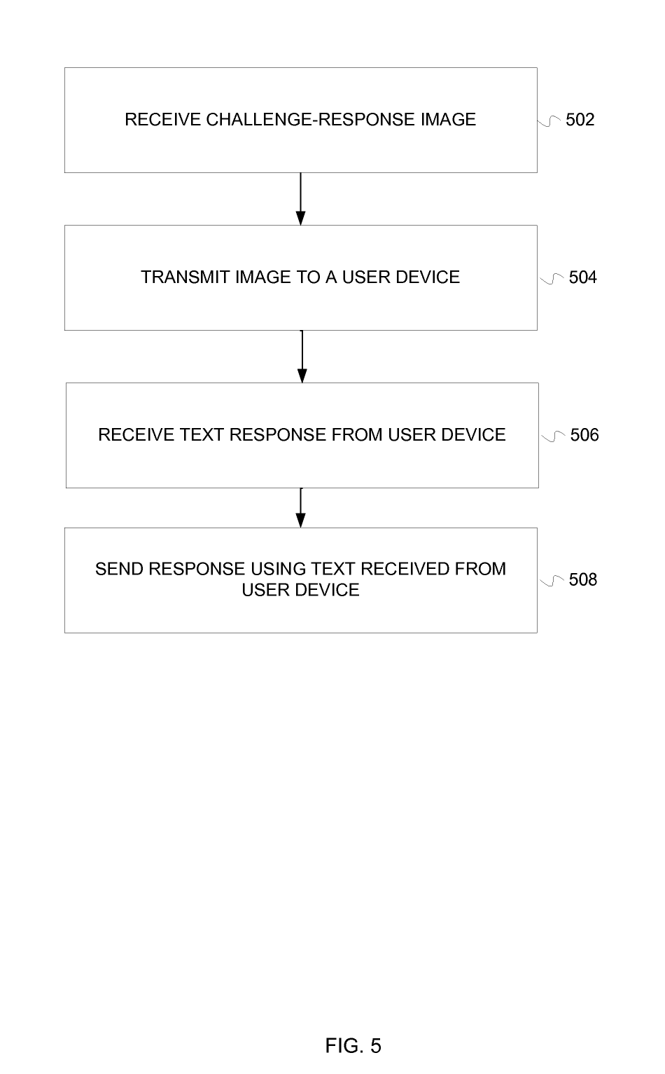

This section will discuss FIGS. 2-5. The discussion of FIG. 2 will describe operations for programmatically accessing online games and satisfying bonus criteria for online games. The discussion of FIGS. 3-4 will describe operations for notifying a user that a bonus criteria has been satisfied for online games. The discussion of FIG. 5 will describe operations for navigating a challenge-response screen according to embodiments.

FIG. 2 is a flowchart illustrating a method 200 for automatically satisfying bonus criteria for multiple online games according to embodiments, for example by a proxy application 104 (FIG. 1). Method 200 begins at block 202 by determining a set of online games associated with a user where the online games have bonus criteria for awarding a bonus. In some embodiments, the set of games will be defined in a database accessible to proxy application 104, for example, configuration database 106. As an example, proxy application 104 may access database 106 and obtain URLs for online game servers hosting online games.

At block 204, proxy application 104 accesses the set of online games. For each online game in the set of online games, proxy application 104 navigates to the online game and supplies any required access credentials such as user ids and passwords. The URLs, user ids and passwords used for accessing an online game may be obtained from configuration data 106 in some embodiments.

At block 206, proxy application 104 programmatically satisfies the bonus criteria for the set of online games. As noted above, the bonus criteria may be different for different games. For some online games, the act of logging into the game may be sufficient to satisfy a bonus criteria. For these types of bonuses, proxy application 104 tracks the bonus period (i.e., the amount of time that must pass since the last time a bonus was awarded) and the time of the most recent bonus award, and uses that information to determine when to login to the online game.

In alternative embodiments, satisfying the bonus criteria may include the proxy application 104 programmatically performing actions. For example, the proxy application may play a mini-game within the online game. As an example, the mini-game may be a card game such as poker, and the proxy application may be suitably programmed to interpret card hands presented on a user interface of the online game and to provide input used by the user interface to play the game. In further alternative embodiments, the proxy application may perform selections of user interface elements in order to satisfy a bonus criteria. The proxy application may be programmed or trained to detect particular configurations of pixels of screen images of the online game and use the detected configurations to navigate through the online game to satisfy bonus criteria for the online game. For example, the proxy application may be configured to detect a flashing button that is part of a user interface for satisfying a bonus criteria for an online game. For example, an online game may provide a pop-up box containing a user interface element that is selected in order to receive a bonus award. The proxy application can be programmed to recognize the pop-up box and to programmatically select the appropriate user interface element. The proxy application may perform more complicated series of actions. For example, the selection of user interface elements may result in actions being performed that lead to a bonus criteria being satisfied. For example, in a farm based simulation game, the proxy application may select user interface elements that pick a field, dig in the field, select crops, and plant crops etc. The proxy application may need to supply input data, such as an answer to a question in order to satisfy a bonus criteria.

In some embodiments, the proxy application may determine an optimal time to satisfy a bonus criteria. As an example, an online game may provide a certain number of points if a user logs in after four hours since the last award, but may award triple points if the user logins in eight hours after last award. The proxy application may be configured to determine to wait until an optimal number of points will be awarded.

It is sometimes the case that a user interface for an online game will change over time. In some embodiments, an administrator can update the proxy application as needed to reflect the changes in the online game.

At block 208, the method optionally notifies the user that bonus criteria for a set of online games have been satisfied. In some embodiments, the proxy application may send an email or text message to a user indicating which online games have had bonuses awarded, and may also include an indication of the bonus amount in the email or the text message. In some embodiments, the proxy application may wait to send a notification message until a threshold number of online games have bonus criteria that have been satisfied in order to avoid flooding a user with messages.

Proxy application 104 may execute method 200 to access online games in a variety of different time sequences. For example, in some embodiments, a set of online games may be accessed in parallel, such that the online games may access simultaneously. In alternative embodiments, proxy application 104 may access some or all of the online games in a set of online games in a sequential manner. This may be desirable in cases where a game server does not allow simultaneous access to games provided on the server.

In further alternative embodiments, proxy application 104 may be configured (for example, using a rule set) to access the set of online games in a way that maximizes bonus awards. As an example, a game provider of a first game A, as an incentive to try games B and C, may provide bonus points in game A if a user plays games B and C. The proxy application rule set may be configured to recognize this case, and access games B and C in a manner that maximizes bonus awards in game A.

In still further alternative embodiments, proxy application 104 may be location aware and only login and access certain online games when the user is in the appropriate location. As an example, consider a casino that offers bonus points for accessing an online game within a casino. A proxy application executing on a user's mobile device may be configured to access the online game when it detects that the user is in or proximate to the casino.

FIGS. 3 and 4 illustrate an example method of highlighting a set of online games that have had bonus criteria satisfied. FIG. 3 illustrates an example screen image 302. For instance, screen image 300 may be a screen image of a web browser and proxy application 104 may be a plug-in for the web browser. Icons 304-310 represent a set of online games that have bonus criteria that are associated with a user of the web browser. In some embodiments, as bonus criteria are satisfied for an online game represented by an icon 304-310, the icon associated with online game may be highlighted. For example, the icon associated with an online game that has bonus criteria that has been satisfied by proxy application 104 may be made to flash, change color, vibrate, rotate etc. In some embodiments, a user may select the icon and upon such selection, be navigated to the associated online game, either in the current window or in a new window. In the example, illustrated in FIG. 3, a 1×4 matrix of online game icons has been illustrated. Those of skill in the art having the benefit of the disclosure will appreciate that other matrix arrangements and sizes are possible and within the scope of the inventive subject matter.

FIG. 4 illustrates an example screen image 400 where an online game having bonus criteria that has been satisfied is highlighted according to alternative embodiments. Screen image 400 may be a screen image of a web browser, and like screen image 300, contains icons 306-310 representing online games having bonus criteria for awarding bonuses. In this example, icon 304 from screen 300 represents an online game for which proxy application 104 has automatically satisfied the bonus criteria. The icon is expanded into a window 404 where the online game may be played by the user. In some embodiments, the online game play may proceed after the proxy application has satisfied the bonus criteria. In alternative embodiments, the online game play may include the user providing information needed to satisfy a bonus criteria for the online game that is not able to be provided by a proxy application. For example, proxy application may logon to the online game on behalf of the user and encounter a bonus criteria that the proxy application is not able to satisfy. In such cases, the proxy application may enlarge the online window as illustrated in FIG. 4 and the user may proceed to satisfy the bonus criteria. In some embodiments, window 404 may overlay a browser window where proxy application 104 is a plug-in. In alternative embodiments, window 404 may be presented outside of screen 400.

Alternative embodiments may provide notification of bonus criteria in different manners that those described above. For example, in some embodiments, the system displays a dashboard in a portion of a display. The dashboard may include aggregated bonus amounts for various online social games associated with a user.

FIG. 5 is a flowchart of a method 500 for satisfying a challenge-response screen by a proxy application 104 according to embodiments. Method 500 begins at block 502 when a challenge-response image is presented on a user interface for an online game that is access by proxy application 104. Challenge-response mechanisms are known in the art, a typically comprise presenting an image of letters or numbers in a sequence where the letters and numbers are deformed, skewed and/or rotated in order to make it difficult for a program to recognized the letters and numbers. An input user interface elements is provided to allow a user to input the recognized letters and numbers presented in the image. An example of a challenge-response mechanism is the “Captcha” challenge-response mechanism.

At block 504 proxy application 104 copies the challenge image and transmits the copy of the challenge image to a user device. The user device may be a user's mobile device such as a mobile phone (smart phone), a table computer, laptop computer or other user device. For example, the challenge image may be captured and transmitted in an email to the user or in a text message sent to a user's mobile device. Alternatively, the copy of the challenge image may be received by an application running on the user's mobile device and presented by the application on a display of the user's mobile device. The user may view the copy of the challenge image presented on the user's mobile device and provide a response in a reply to the email or text message, or in a user interface of an application running on the user's mobile device.

At block 506, the proxy application 104 receives the response from the user's mobile device and at block 508 copies the response to the response user interface element of the challenge-response mechanism.

If the proper response has been provided, proxy application may go on to satisfy the bonus criteria for the online game using the challenge-response mechanism. If an incorrect response has been provided, blocks 302-306 may be repeated with a new challenge image.

As can be seen from the above, the user's mobile device acts as a relay device, where the challenge image is relayed from a computer originally receiving the challenge image (e.g., a computer running a proxy application) to a user device that is not associated with the original challenge-response transaction. Similarly, the response is relayed from the user's mobile device to the computer originally receiving the challenge image.

Although method 500 has been described in the context of a mobile device acting as a relay device for a challenge-response sequence, any remote computing device may serve as a relay device. For example, a user may have a proxy application running on a personal or home computing system and receive copy of the challenge image on a work computer or second personal home computing system.

### Example Computing Systems

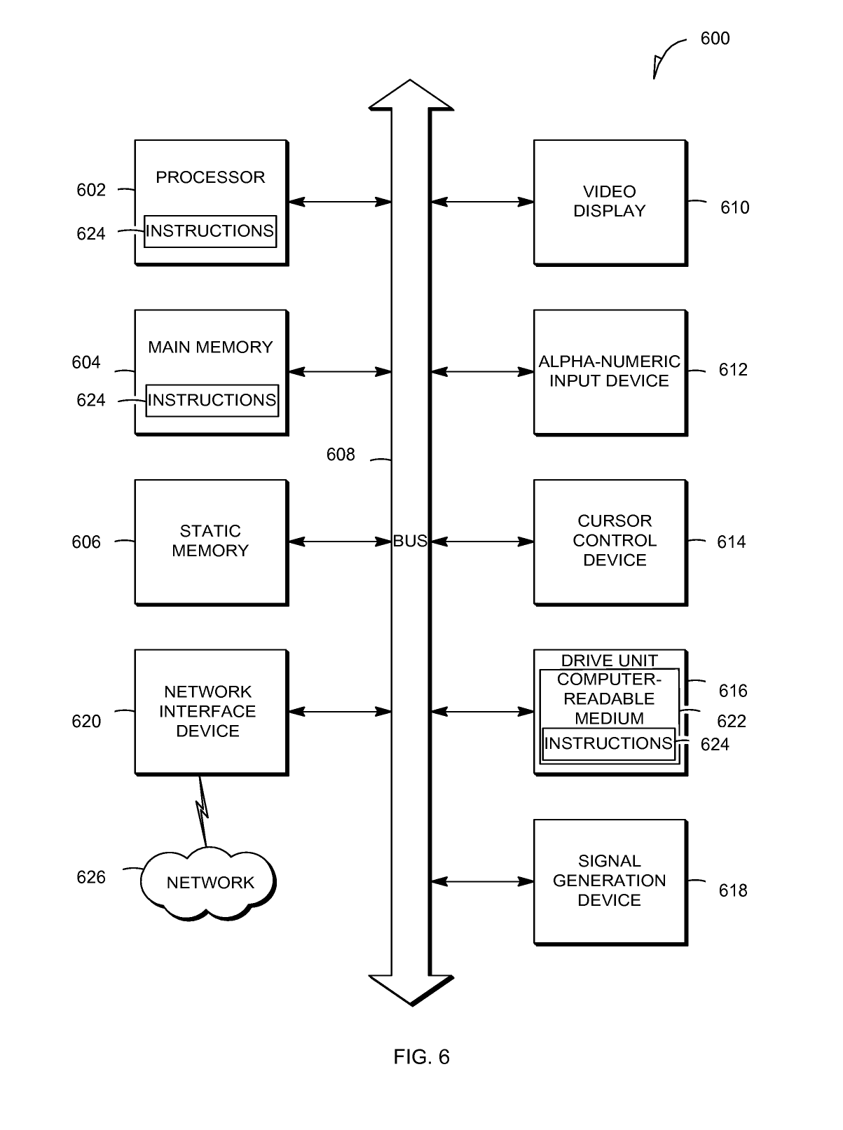

FIG. 6 is a block diagram of an example embodiment of a computer system 600 upon which embodiments of the inventive subject matter can execute. The description of FIG. 6 is intended to provide a brief, general description of suitable computer hardware and a suitable computing environment in conjunction with which the invention may be implemented. In some embodiments, the invention is described in the general context of computer-executable instructions, such as program modules, being executed by a computer. Generally, program modules include routines, programs, objects, components, data structures, etc., that perform particular tasks or implement particular abstract data types.

As noted above, the system as disclosed herein can be spread across many physical hosts. Therefore, many systems and sub-systems of FIG. 6 can be involved in implementing the inventive subject matter disclosed herein.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 6, a hardware and operating environment is provided that is applicable to both servers and/or remote clients.

With reference to FIG. 6, an example embodiment extends to a machine in the example form of a computer system 600 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the methodologies discussed herein.

The example computer system 600 may include a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). In example embodiments, the computer system 600 also includes one or more of an alpha-numeric input device 612 (e.g., a keyboard), a user interface (UI) navigation device or cursor control device 614 (e.g., a mouse), a disk drive unit 616, a signal generation device 618 (e.g., a speaker), and a network interface device 620.

The disk drive unit 616 includes a machine-readable medium 622 on which is stored one or more sets of instructions 624 and data structures (e.g., software instructions) embodying or used by any one or more of the methodologies or functions described herein. The instructions 624 may also reside, completely or at least partially, within the main memory 604 or within the processor 602 during execution thereof by the computer system 600, the main memory 604 and the processor 602 also constituting machine-readable media.

While the machine-readable medium 622 is shown in an example embodiment to be a single medium, the term “machine-readable medium” may include a single medium or multiple media (e.g., a centralized or distributed database, or associated caches and servers) that store the one or more instructions. The term “machine-readable medium” shall also be taken to include any medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. Machine-readable media may include machine-readable storage media and machine-readable signal media. The term “machine-readable storage medium” shall accordingly be taken to include, but not be limited to, solid-state memories and optical and magnetic media that can store information in a non-transitory manner, i.e., media that is able to store information for a period of time, however brief. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 624 may further be transmitted or received over a communications network 626 using a transmission medium via the network interface device 620 and utilizing any one of a number of well-known transfer protocols (e.g., FTP, HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “machine-readable transmission medium” shall be taken to include any intangible medium that is capable of storing, encoding, or carrying instructions for execution by the machine, and includes digital or analog communications signals or other intangible medium to facilitate communication of such software. Such communications signals may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A method comprising:
determining a set of online games associated with a user, each online game having a bonus criteria for awarding a bonus;
accessing, by a proxy application executable by one or more processors, the set of online games; and
satisfying the bonus criteria of each online game of the set of online games.

2. The method of claim 1, wherein accessing the set of online games includes:
logging into an online game of the set of online games by the proxy application; and
navigating, by the proxy application, one or more user interface elements associated with the online game.

3. The method of claim 2, wherein the bonus criteria includes an expiration of a time period and wherein logging into the online game satisfies the bonus criteria.

4. The method of claim 1, wherein satisfying the bonus criteria includes performing, by the proxy application, one or more game actions that contribute to satisfying the bonus criteria for an online game in the set of online games.

5. The method of claim 4, wherein performing one or more game actions includes picking a user interface element, providing an answer to a question, or playing a portion of the online game.

6. The method of claim 1, wherein accessing the set of online games includes:
receiving, by the proxy application, a challenge-response screen for an online game;
sending an image of the challenge-response screen to a user device;
receiving, by the proxy application, a response from the user device;
providing, by the proxy application, the response to the challenge-response screen.

7. The method of claim 1, wherein accessing the set of online games includes utilizing an application program interface for at least one online game of the set of online games.

8. The method of claim 1, further comprising notifying the user that the bonus criteria for an online game in the set of online games has been satisfied.

9. The method of claim 8, further comprising presenting simultaneously at least a portion of an interface screen for each online game of the set of online games, and wherein notifying the user that the bonus criteria has been satisfied for an online game in the set of online games includes highlighting the interface screen associated with the online game.

10. The method of claim 9, wherein highlighting the interface screen includes zooming the interface screen.

11. The method of claim 8, wherein notifying the user that the bonus criteria has been satisfied comprises deferring the notification until a threshold number of the set of online games have bonus criteria that have been satisfied.

12. A system comprising:
one or more processors;
at least one memory device storing instructions associated with a proxy application, that when executed by the one or more processors, cause the system to:
determine a set of online games associated with a user, each online game having a bonus criteria for awarding a bonus;
access, by the proxy application, the set of online games; and
satisfy the bonus criteria of each online game of the set of online games.

13. The system of claim 12, wherein the instructions to access the set of online games include instructions to cause the proxy application to:
login to an online game of the set of online games; and
navigate one or more user interface elements associated with the online game.

14. The system of claim 13, wherein the bonus criteria includes an expiration of a time period and wherein login to the online game satisfies the bonus criteria.

15. The system of claim 12, wherein the instructions to satisfy the bonus criteria include instructions to perform, by the proxy application, one or more game actions that contribute to satisfying the bonus criteria for an online game in the set of online games.

16. The system of claim 15, wherein the instructions to perform one or more game actions include instructions to pick a user interface element, provide an answer to a question, or play a portion of the online game.

17. The system of claim 12, wherein the proxy application comprises a plug-in for a web browser.

18. The system of claim 12, wherein the instructions further comprise instructions to notify the user that the bonus criteria for an online game in the set of online games has been satisfied.

19. The system of claim 18, wherein the instructions further comprise instructions to present simultaneously at least a portion of an interface screen for each online game of the set of online games, and wherein the instructions to notify the user that the bonus criteria has been satisfied for an online game in the set of online games include instructions to highlight the interface screen associated with the online game.

20. The system of claim 18, further comprising a rules engine, the rules engine configured to interpret rules for accessing the set of online games or navigating within an online game of the set of online games.

21. The system of claim 18, wherein the rules engine interprets rules to access two or more online games of the set of online games in a sequence that maximizes a bonus award for at least one of the two or more online games.

22. A machine-readable storage medium having stored thereon machine executable instructions for causing one or more processors to perform operations comprising:
determining a set of online games associated with a user, each online game having a bonus criteria for awarding a bonus;
accessing, by a proxy application executable by the one or more processors, the set of online games; and
satisfying the bonus criteria of each online game of the set of online games.

23. The machine-readable storage medium of claim 22, wherein accessing the set of online games includes:
logging into an online game of the set of online games by the proxy application; and
navigating, by the proxy application, one or more user interface elements associated with the online game.

24. The machine-readable storage medium of claim 23, wherein the bonus criteria includes an expiration of a time period and wherein logging into the online game satisfies the bonus criteria.

25. The machine-readable storage medium of claim 22, wherein satisfying the bonus criteria includes performing, by the proxy application, one or more game actions that contribute to satisfying the bonus criteria for an online game in the set of online games.

26. The machine-readable storage medium of claim 25, wherein performing one or more game actions includes picking a user interface element, providing an answer to a question, or playing a portion of the online game.

27. The machine-readable storage medium of claim 22, wherein accessing the set of online games includes:
receiving, by the proxy application, a challenge-response screen for an online game;
sending an image of the challenge-response screen to a user device;
receiving, by the proxy application, a response from the user device;
providing, by the proxy application, the response to the challenge-response screen.

28. The machine-readable storage medium of claim 22, wherein accessing the set of online games includes utilizing an application program interface for at least one online game of the set of online games.

29. The machine-readable storage medium of claim 22, wherein the operations further comprise notifying the user that the bonus criteria for an online game in the set of online games has been satisfied.

30. The machine-readable storage medium of claim 29, wherein the operations further comprise presenting simultaneously at least a portion of an interface screen for each online game of the set of online games, and wherein notifying the user that the bonus criteria has been satisfied for an online game in the set of online games includes highlighting the interface screen associated with the online game.

31. The machine-readable storage medium of claim 22, wherein the instructions further comprise instructions to access two or more online games of the set of online games in a sequence that maximizes a bonus award for at least one of the two or more online games.
